(19) United States
(12) Patent Application Publication
(10) Pub. No.: US 2014/0001180 A1
(43) Pub. Date: Jan. 2, 2014

(54) LIQUID POUCH WITH DISPENSING FITMENT AND SUPPORT PITCHER

(71) Applicants: Paul D. GAGE, High Point, NC (US); Steve Bajinski, Suwanee, GA (US); Raimund GERSTNER, Bucaramanga (CO)

(72) Inventors: Paul D. GAGE, High Point, NC (US); Steve Bajinski, Suwanee, GA (US); Raimund GERSTNER, Bucaramanga (CO)

(73) Assignee: HOOD PACKAGING CORPORATION, Burlington (CA)

(21) Appl. No.: 13/534,809

(22) Filed: Jun. 27, 2012

(51) Int. Cl. B67D 7/06; B65D 1/40; B67D 7/84

(52) U.S. Cl. 220/62.12; 222/173; 222/107

(57) ABSTRACT

A liquid pouch is comprised by a polymeric film material bag which has a front and a rear wall. The front and rear walls define a top and bottom edge and opposed side edges. A dispensing fitment is secured in an upper region of the pouch spaced from the top edge. The dispensing fitment has a rigid spout neck with a removable closure member. An attachment flange wall surrounds the spout neck and is secured to the plastic film material. The spout neck has a base formation shaped for friction fit retention in a connecting slot of a support member. The pitcher has a connecting slot formed in an upper edge thereof with the slot having a bottom retention section to receive the engageable formation in retention fit therein to retain the bag containing liquid secured thereto for dispensing the liquid through the spout neck.

### TECHNICAL FIELD

The present invention relates to a liquid pouch having a dispensing fitment adapted to be removable retained in a connecting slot of a pitcher.

### BACKGROUND ART

Fitments for flexible bags are known and such a fitment is, for example, described in U.S. Pat. No. 6,053,360. These fitments are adapted to dispense a liquid contained in various collapsible bags or containers and some of these are provided with tubes, such as shown in the aforementioned patent which extends through a hole of a rigid container or else are disposed within a mechanical valve which opens and closes the tube to dispense the liquid from the bag. These fitments are usually mounted at the bottom of the bag whereby liquid can be discharged by gravity. In other applications liquid can be withdrawn from the bag by suction through their spouts or fitments. The bag is typically constructed of sheets of plastic material formed of polyethylene, polypropylene, nylon or polyester material. These bags usually contain various consumable liquids such as milk, juices, syrups, etc. Liquids used for industrial applications, such as chemicals, can also be packaged in such bag structures.

A common use of such bag is to dispense milk from milk pouches. Pitchers are provided whereby to contain the milk pouch and for dispensing the milk therefrom. U.S. Pat. Nos. 4,653,671, 3,799,400 and 3,606,962 show an example of such pitchers wherein a milk pouch or other liquid pouch is placed within the pitcher and an upper corner portion of the pouch is cut out by the use of scissors to form a dispensing opening. A disadvantage of such containers is that as the liquid diminishes within the pouch, the pouch collapses within the container making the dispensing non-uniform and sometimes causing the pouch to fall out of the pitcher, this particularly so when handled by children. Further, the open clipped corner of the pouch remains exposed to the environment and can pick-up odors or contamination of its contents.

Another disadvantage of such bags or pouches and containers is that often the dispensing spout is formed too large due to the fact that a larger corner portion of the bag is cut out, again particularly when handled by children and this causes the liquid to be dispensed too quickly out of the bag. Liquid can also be trapped within the bag by buckling of the bag when the liquid contents therein are substantially reduced in volume.

A still further disadvantage of bags containing liquids is the securement of the fitment to the bag. These fitments are usually heat sealed to the side wall of the bag and sometimes too close to edge seals or on a folded edge of the film and this causes imperfect welds and leaking in the surrounding area of the fitment where the film is often stretched and thinned out, making it easy to tear and causing leakage of the content.

Another disadvantage of fitments is that these are usually provided with threaded caps to seal the dispensing spout when it is not necessary to dispense liquid from the pouch. By threading and unthreading the dispensing cap, forces are applied about the spout and into the sealing flange thereabout causing tear of the plastics material in its weakened surrounding area. All of these disadvantages deter consumers from choosing flexible liquid pouches over traditional rigid liquid containing containers.

A still further disadvantage is that most of these pouches are made of a mix of polymers in laminated or co-extruded forms which are difficult to recycle into useful products.

Another disadvantage is that self-supporting pouches are much less rigid when compared to conventional pitchers, and they are more difficult to utilize due to the collapse of the pouch as the liquid is disposed.

### SUMMARY OF INVENTION

It is a feature of the present invention to provide a liquid pouch with a dispensing fitment and a support pitcher for use therewith which substantially overcomes all of the above-mentioned disadvantages of the prior art.

According to the above features, from a broad aspect, the present invention provides a liquid pouch comprised by a polymeric film material bag which has a front and a rear wall. The front and rear walls have a top and bottom edge and opposed side edges. A dispensing fitment is secured in an upper region of the pouch spaced from the top edge. The dispensing fitment has a rigid spout neck with a removable closure member. An attachment flange wall surrounds the spout neck and is secured to the plastic film material. The spout neck has a base formation shaped and formed for secured retention in a connecting slot of a support member.

According to a further broad aspect of the present invention there is provided a pitcher for dispensing liquid from a pouch having a dispensing fitment provided with an engageable formation formed integral with a spout neck thereof. The pitcher has a connecting slot formed in an upper edge thereof. The connecting slot has a bottom retention section defined between opposed straight edges spaced apart to receive the engageable formation in close fit retention therein. Retention means is provided to secure the base formation in the bottom retention section.

According to a still further broad aspect of the present invention the engageable formation of the fitment is retained within the retention section of the connecting slot by spring friction fit and/or retention projections.

According to a further broad aspect of the present invention the engageable formation of the fitment is retained within the retention section of the connecting slot by a retention projection formed in each of opposed straight edges of the connecting slot with the retention projections being transversely aligned with one another and extending above the engageable formation.

According to a still further broad aspect of the present invention there is provided a liquid dispensing fitment formed of polymeric material for securement to a flexible bag. The fitment has a dispensing spout neck having a dispensing end. A removable closure member is adapted to be secured to an open end of the spout neck. A flange wall is formed integral about an attachment end of the spout neck. The spout neck has a base formation shaped for close fit retention in a connecting slot of a dispensing support member.

### BRIEF DESCRIPTION OF DRAWINGS

A preferred embodiment of the present invention will now be described with reference to the accompanying drawings in which:

FIG. 1 is a plan view of a liquid pouch provided with the dispensing fitment of the present invention;

FIG. 2A is a side view of the fitment;

FIG. 2B is a front view of the fitment;

FIG. 3A is a plan view of a preferred embodiment of the liquid pouch wherein the top and bottom edges of the pouch are angulated;

FIG. 3B is a further plan view of the pouch of FIG. 3A showing the liquid level therein as well as the reduced air space at the top end of the bag and the reduction in plastic film material used to construct this bag;

FIG. 4 is a schematic cross-sectional side view of the fitment showing a feature of its flexible attachment flange wall;

FIG. 5 is a fragmented section view showing a further example of the construction of the flange wall to add rigidity to the fitment;

FIG. 6A is a perspective view of a pitcher containing the connecting slot for retention of the fitment of the present invention therein;

FIG. 6B is a cross-section side view of the pitcher;

FIG. 7 is a front view illustrating the construction of the connecting slot; and

FIG. 8 is a top view of the reinforced pitcher wall in which the connecting slot is formed.

### DESCRIPTION OF PREFERRED EMBODIMENTS

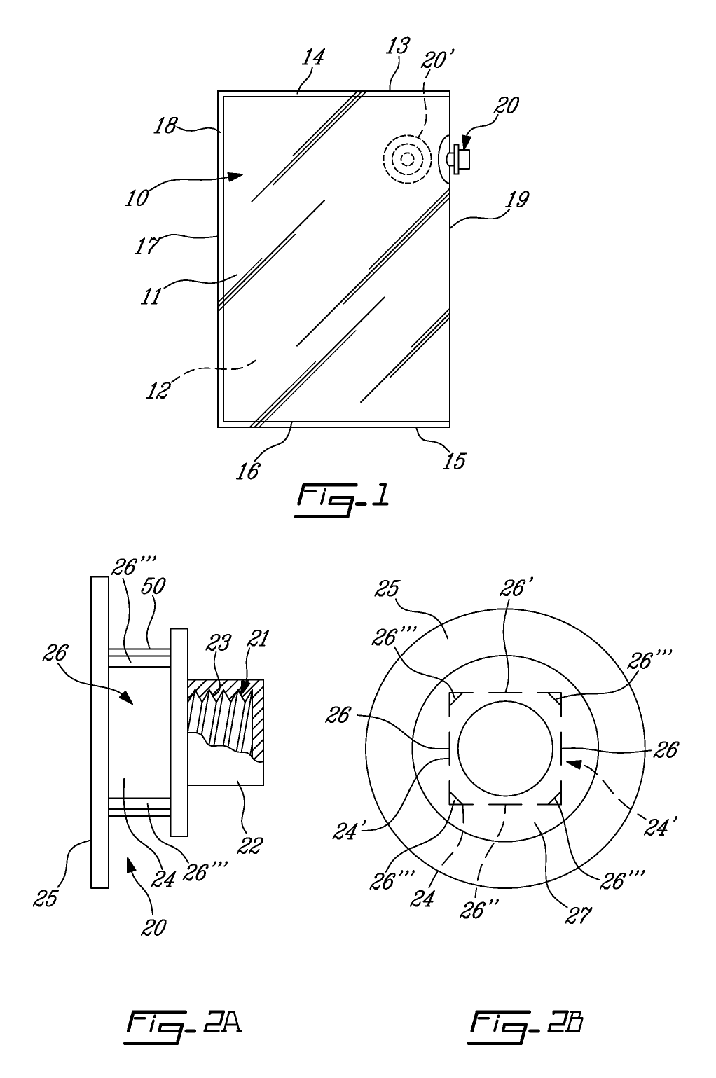

Referring now to the drawings, and more particularly to FIGS. 1 to 4, there is shown generally at 10 a liquid pouch which is formed of polymeric film material formed of PE, PP PET, EVA, EMA, PVC, LLDPE and PP and blends and copolymers of these products in the density range of 0.88 to 0.945 with a Melt Index of 0.25 to 5.0. The pouch film may also consist of laminations as well as single layers of polymer film or co-extrusions, such as, for example, PET/PE; BOPP/PE; Nylon/PE; PP/PE; MetPET/PE; and MetBOPP/PE, and equipped with the fitment 20 of the present invention. The pouch or bag 10 has a front wall 11 and a rear wall 12. The pouch may be formed by different heat fusing processes and as hereinshown the bag further defines a top edge 13 formed by a heat seal 14, a bottom edge 15 formed by a further heat seal 16 and a side edge 17 formed by another heat seal 18. The opposed side edge 19 is formed by a fold of a plastic sheet folded upon itself to form the front and rear walls 11 and 12, respectively.

As shown in FIG. 1, a dispensing fitment 20 molded of plastics material is secured to the pouch in the folded side wall 19. Alternatively, as shown in dotted lines at 20′, the fitment may be secured to the front or rear walls adjacent a corner thereof and spaced from the top edge 13.

Referring now more specifically to FIGS. 2A and 2B, the dispensing fitment 20 has a rigid spout neck 21 with a removable closure member 22 detachably secured thereto. The closure member 22 is a threaded screw cap threadably secured to the threads 23 formed about the spout neck 21. The spout neck has a base formation 24 shaped for close fit retention in a connecting slot of a support member as will be described later. An attachment flange wall 25 surrounds the base formation at a rear end thereof for securement to the plastic film material of the pouch 10. The flange wall 25 is preferably, but not exclusively, flexible.

As shown in FIG. 2B, the base formation 24 has at least a section thereof, herein the opposed vertical side walls 26 thereof, shaped to define vertical side walls 26 extending parallel to one another and shaped for close fit retention in a connecting slot of a pitcher as will be described later. In one embodiment, the base formation is retained in snug friction fit in the connecting slot of the pitcher and prevent the pouch and fitment from falling out of the pitcher. As shown in FIGS. 2A and 2B, the base formation has upper and lower transverse walls 26′ and 26″, respectively, and connected to the vertical walls at their ends through angled corner brace walls 26′″ which transfer compression forces between the side walls to the top and bottom walls 26′ and 26″ when press-fitted in the connecting slot. This snug fit prevents the pouch from slipping out of the pitcher when the pitcher is displaced to pour liquid out of the pouch. The flexible attachment flange 25, in the current embodiment, is formed of a polymeric material having a melt index of between 0.2 to 50 MI (melt index) and a density of 0.912 to 0.960. The flexible attachment flange 25 is formed of polyethylene materials including HDPE, LDPE and LLDPE and copolymers.

As shown in FIG. 4, the flexible attachment flange 25 is adapted to flex during the heat fusing or ultrasonic welding of the fitment onto the plastic film bag. During the securement operation, the film material of the pouch herein identified by the film material of the front wall 11 exerts a pulling force on the flange 25 and the flexing of the flange prevents the formation of weakened areas or stretched areas in the margin 27 at the intersection of the pouch film material 11 and the flexible attachment flange wall 25. The flexing of the flange 27 is caused by a shear force applied at the interface or margin area 27 during heat fusing or ultrasonic welding of the fitment to the film in a sealing jaw. As also shown in FIG. 4, an intermediate circumferential retention and reinforcing flange 27 separates the spout neck 21 from the base formation 24. In one embodiment, the film used was 4 mil and the sealing temperature was about 390° F. at a dwell time of about 2 seconds at suitable sealing jaw pressure.

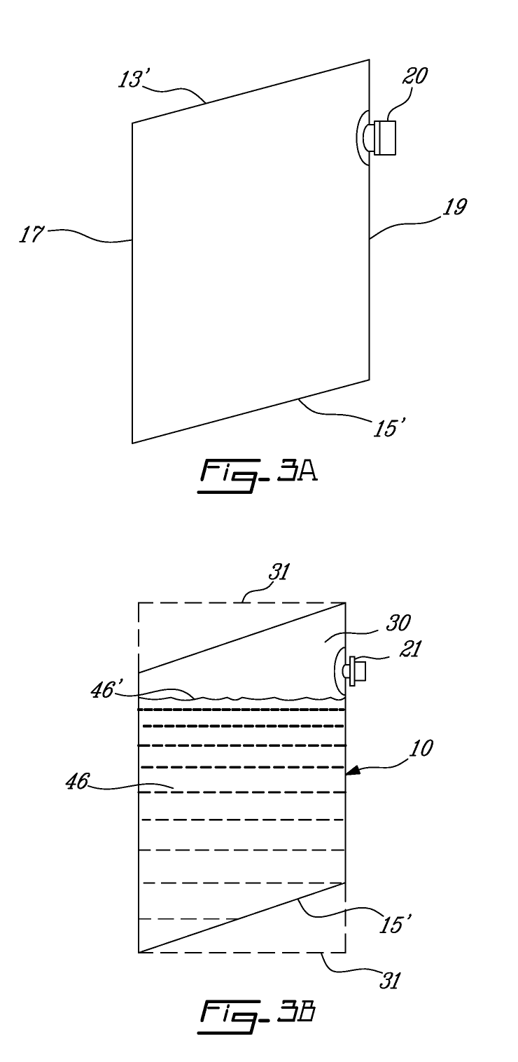

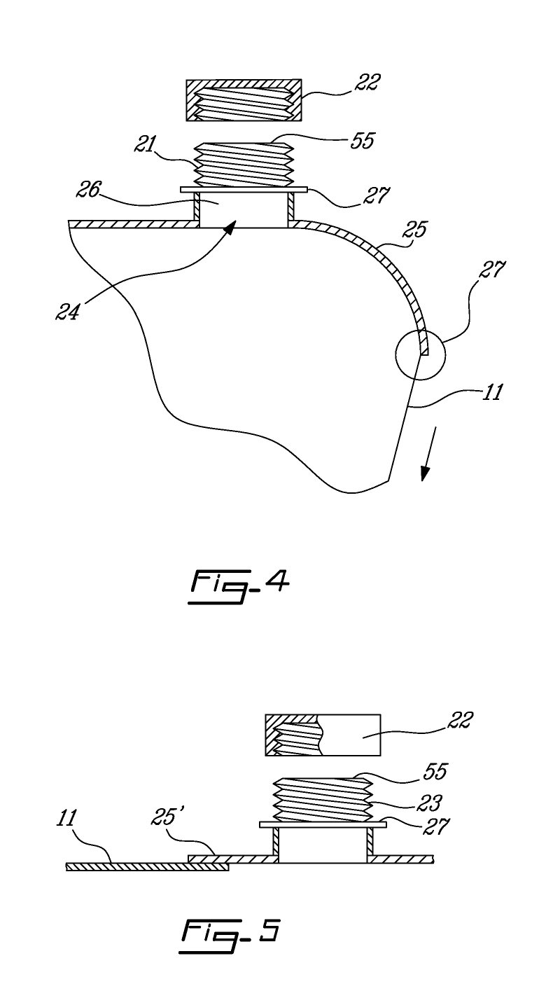

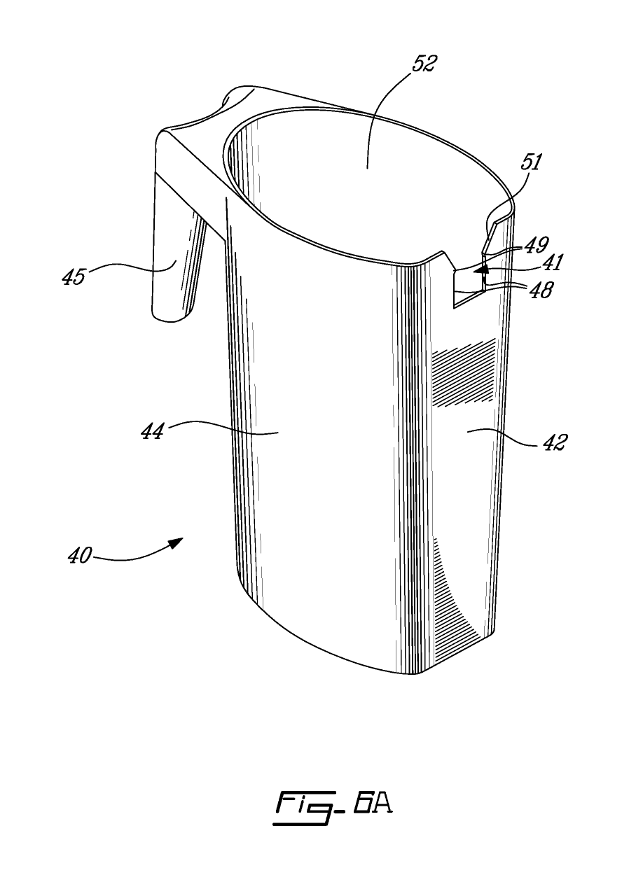

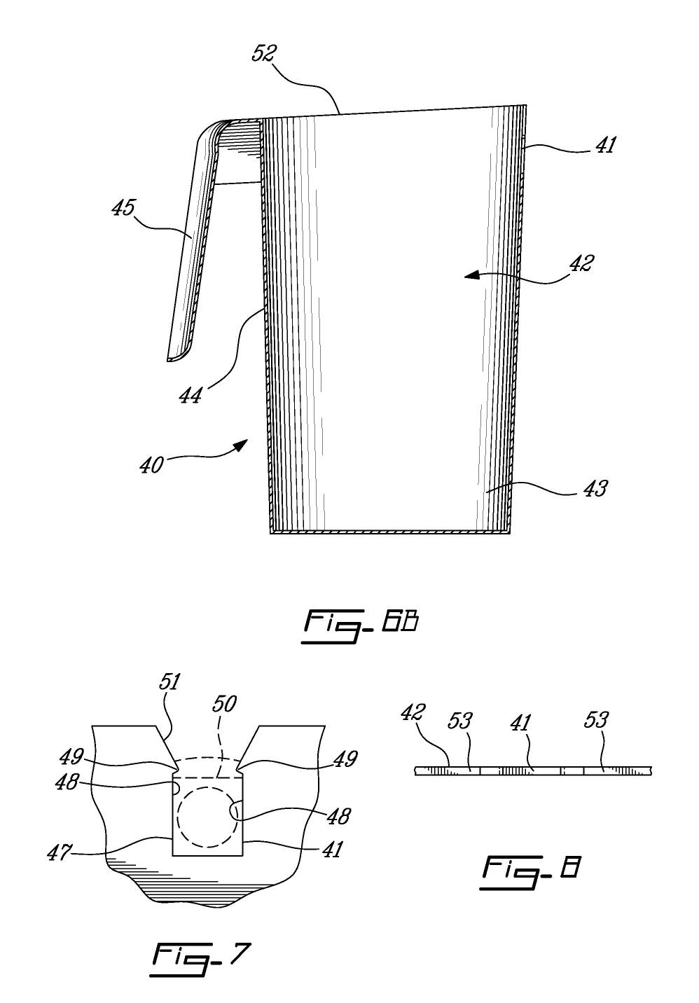

The base formation 24 and the spout neck 21 and screw cap 22 may be formed of a mixture of 30% LLDPE having a density of 0.924 and 70% of LDPE having a density of 0.921. The mixture may also have the same ranges and materials as that of the pouch. The base formation 24 is formed with sufficient rigidity to withstand torque applied to the neck when screwing and unscrewing the cap, particularly when the base formation is immovably retained in a connecting slot of a pitcher. A retention flange 27 is provided at the front end of the base formation and about the spout neck 21 which solidifies the base formation and prevents the fitment from being pushed inwardly when the fitment is engaged in a retention slot of a pitcher as shown in FIG. 6A. A further means of reinforcing the base formation 24 can be provided by constructing the attachment flange 25 with a taper, as illustrated in FIG. 5, wherein the flange 25′ has a thicker portion at the base formation 24 tapering outwardly to its circumferential periphery where it needs to be more flexible. The thickness shown in FIG. 5 is exaggerated simply to illustrate the thickened flexible attachment flange wall adjacent the base formation.

Referring now to FIGS. 3A and 3B, there is illustrated a preferred embodiment of the liquid pouch 10 wherein the top edge 13′ and the bottom edge 15′ are angulated parallel edges sloping upwardly from side edge 17 towards side edge 19 in the direction of the dispensing fitment 20 secured in the upper region of the pouch. The sloping bottom edge 15′ extends at an angle of 75° with respect to the side edge 17. The reason for such sloped bottom and top edges is better illustrated in FIG. 3B wherein it can be seen that the space area 30 at the top end of the bag is reduced saving on plastics material to form the bag. The area delineated by broken lines 31 depicts the material that has been saved as opposed to the formation of a rectangular pouch. Also, the angulated bottom edge 15′ permits a better flow of liquid out of the pouch through the spout opening when the pouch is retained in a pitcher having a sloped bottom wall as will be described hereinbelow. For the containment of one liter of liquid the pouch size has a height of 9.25 inches and a width of 6 inches. Other possible configurations of the pouch are contemplated as well as for the fitment, for example, the flanges may have a rectangular contour or other shape. Other pouch shapes are also envisaged.

With reference now to FIGS. 6A and 6B, there will be described the construction of the support member, herein constituted by a pitcher 40. The pitcher 40 is provided with a connecting slot 41 formed in an upper edge thereof, herein in the upper edge of a front wall 42. As shown in FIG. 6B, the pitcher also has an inclined bottom wall 43 extending upwardly in the direction of the connecting slot 41. The pitcher defines surrounding side walls 44 and has a handle 45 adjacent a rear upper end thereof. The inclined bottom wall 43 has an angle wherein the bottom edge 15′ of the liquid pouch extends coplanar therewith when the pouch with a liquid 46 therein is disposed within the pitcher.

The connecting slot 41 has a bottom retention section 47 which is defined between opposed spaced-apart straight edges 48. The straight edges 48 are spaced apart a distance to receive the opposed vertical side walls 26 of the base formation 24 in close fit therein, preferably slightly compressed friction fit. As shown in FIG. 7, the connecting slot 41 defines a bottom retention section which is delineated below retention projections 49 formed in the opposed side edges 48. These retention projections 49 extend slightly over the top wall 50 of the base formation 24, hereinshown in phantom line in FIG. 7. As hereinshown the top wall of the base formation is a flat top wall as well as the bottom wall of the base formation 24. Accordingly, the base formation 24 is retained captive by the retention projections 49 and cannot slide outwardly of the connecting slot 41 unless an upward puling force is applied by the user person. The top end of the connecting slot has sloped edges 51 to facilitate the placement of the fitment within the connecting slot. The retention projections 49 constitute retention means to capture the base formation of the fitment in the bottom retention section of the retention slot. The fitment base formation 24 may also constitute the retention means by friction fit retention between the opposed straight edges 48 of the connecting slot 41. The slot 41 can be shaped differently to provide friction fit retention with the base formation 24, such as conic, and may have a curved bottom edge, etc. The projections 49 may thus not be necessary. However, the retention projections 49 assure a more secure connection.

The pitcher is formed of plastics material and preferably, but not exclusively, this plastic material can be thickened in the area 53 surrounding the connecting slot 41, as illustrated in FIG. 8. An advantage of that thickened area is to provide rigidity about the base formation 24 of the fitment which is also reinforced to resist torsion when screwing or unscrewing the cap to prevent disconnection of the fitment within the connecting slot and prevent damaging of the connection of the fitment with the film material to which it is attached. The pitcher 40 defines a pouch receiving chamber 52 of oval shape cross-section which is dimensioned for receiving the pouch with liquid therein in close fit and with the fitment secured in the connecting slot. A cover, not shown, may be fitted over the top end of the chamber 52 to conceal the pouch. As shown in FIG. 3B, the liquid 46 within the pouch 10 has a top level 46′ which extends a predetermined distance below the spout neck 21 of the fitment whereby to prevent spillage when removing the closure seal member 55 after the fitment is positioned within the pitcher connecting slot 41. This removable closure seal member assures that the content of the pouch has not been tampered with and seals the dispensing opening during transportation and handling prior to use by the consumer. The closure screw cap prevents surrounding strong odors from having an effect on the taste of the liquid by absorption. The ideal height of the pitcher for a one quart liquid pouch is established at 9.5 inches. This allows for almost no slack of the liquid pouch with the fitment secured in the slot. If the pouch was significantly longer than the eight of the pitcher, the pouch could buckle in the mid-region thereof during use. Therefore, when the pouch seems empty, the wrinkle or crimping in the pouch, caused by the buckling in the film, would cause the liquid to pool, leaving liquid in the pouch.

When the pouch is fitted within the pitcher 40 and the pitcher is tilted forwardly towards the dispensing fitment 20, the sloped bottom wall 15′ facilitates in the dispensing of all of the liquid within the pouch due to its sloping wall extending towards the fitment, preventing liquid from being retained within the pouch due to the deformation of the pouch with the film material collapsing and being distorted and forming liquid retention cavities.

It is within the ambit of the present invention to cover any obvious modifications of the preferred embodiment described herein, provided such modifications fall within the scope of the appended claims.

1. A liquid pouch comprised by a polymeric film material bag having a front and rear wall, said front and rear walls having a top and bottom edge and opposed side edges, a dispensing fitment secured in an upper region of said pouch spaced from said top edge, said dispensing fitment having a rigid spout neck with a removable closure member, said spout neck having a base formation shaped for close fit retention in a connecting slot of a dispensing support member, and an attachment flange wall surrounding said spout neck and secured to said plastic film material.

2. A liquid pouch as claimed in claim 1 wherein some of said edges are formed by weld seals and at least one side edge formed by a fold of said film material.

3. A liquid pouch as claimed in claim 2 wherein said base formation has at least a section thereof having opposed parallel vertical walls and wherein said connecting slot has a bottom retention section having opposed straight edges spaced-apart to retain said base formation section having said opposed parallel vertical walls.

4. A liquid pouch as claimed in claim 1 wherein said attachment flange wall is a flexible attachment flange wall formed of a polymerized material having a melt index of between 0.2 to 50 MI and a density of 0.912 to 0.960.

5. A liquid pouch as claimed in claim 4 wherein said flexible attachment flange is formed of polyethylene materials including HDPE, LDPE, LLDPE and blends and copolymers.

6. A liquid pouch as claimed in claim 1 wherein said removable closure member is a screw cap removably secured to a threaded free-end portion of said spout neck, said free end portion having a dispensing opening, and a detachable seal member removably retained about said dispensing opening.

7. A liquid pouch as claimed in claim 4 wherein said removable closure member is a screw cap, said base formation of said spout neck and said screw cap being formed of a mixture of 30% LLDPE having a density of 0.924 and 70% LDPE having a density of 0.921.

8. A liquid pouch as claimed in claim 2 wherein said flexible attachment flange of said dispensing fitment is secured by one of heat sealing or ultrasonic welding to said side edge formed by a fold.

9. A liquid pouch as claimed in claim 8 wherein said top and bottom edge and one of said opposed side edges are heat sealed edges, the other of said side edge being said side edge formed by a fold.

10. A liquid pouch as claimed in claim 1 wherein said flexible attachment flange of said dispensing fitment is heat sealed to one of said front and rear wall in said upper region of said spout and closely spaced to one of said opposed side edges.

11. A liquid pouch as claimed in claim 1 wherein said top and bottom edges are parallel angulated edges sloping upwardly form one of said opposed side edges in the direction of said dispensing fitment secured in said upper region of said pouch.

12. A liquid pouch as claimed in claim 11 wherein said support member is a pitcher having said connecting slot formed in an upper edge thereof, said pitcher having an inclined bottom wall extending upwardly in the direction of said connecting slot, said angulated bottom edge of said pouch extending co-planar with said bottom wall when said pouch with liquid therein is positioned in said pitcher with said base formation of said spout neck retained in said connecting slot.

13. A liquid pouch as claimed in claim 12 wherein said connecting slot has a bottom retention section for receiving said base formation in close fit therein, said bottom retention section having opposed parallel side edges provided with retention projections to capture said base formation in said bottom retention section.

14. A liquid pouch as claimed in claim 12 wherein said pitcher is formed with a thickened material area surrounding said connecting slot to provide resistance to a torque force transmitted to said material adjacent said connecting slot when said removable closure member is engaged and disengaged.

15. A liquid pouch as claimed in claim 14 wherein said removable closure member is a screw cap.

16. A liquid pouch as claimed in claim 3 wherein said base formation is retained by friction fit, said base formation having an upper and lower wall extending transversely to said opposed parallel vertical walls and connected thereto through angled corner brace walls to transfer compression forces to said top and bottom walls when said base formation is compressed between said opposed straight edges of said connecting slot.

17. A liquid pouch wherein said pouch is formed of polymeric film material such as PE, PP PET, EVA, EMA, PVC, LLDPE and PP and blends and copolymers of these products in the density range of 0.88 to 0.945 with a Melt Index of 0.25 to 5.0 and single layers of polymer film or co-extrusions, such as, PET/PE; BOPP/PE; Nylon/PE; PP/PE; MetPET/PE; and MetBOPP/PE.

18. A pitcher for dispensing liquid from a pouch having a dispensing fitment provided with an engageable formation formed integral with a spout neck thereof, said pitcher having a connecting slot formed in an upper edge thereof, said connecting slot having a bottom retention section defined between opposed parallel straight edges spaced apart to receive said engageable formation in close fit therein, and retention means to capture said base formation in said bottom retention section.

19. A pitcher as claimed in claim 18 wherein said retention means is constituted by a retention projection formed in each of said opposed straight edges, said retention projections being transversely aligned with one another.

20. A pitcher as claimed in claim 18 wherein said pitcher has an inclined bottom wall extending upwardly in the direction of said connecting slot.

21. A pitcher as claimed in claim 20 wherein said pitcher is provided with a handle formed in a side wall thereof opposite said connecting slot.

22. A pitcher as claimed in claim 19 wherein said connecting slot is provided with a flared top section having sloped edges leading to said bottom retention section to facilitate locating said dispensing fitment thereinto.

23. A pitcher as claimed in claim 19 wherein said engageable formation has opposed parallel vertical walls spaced-apart for friction fit retention in said bottom retention section of said connecting slot, said fitment having a retention flange disposed forwardly of said connecting slot and extending thereacross.

24. A pitcher as claimed in claim 18 wherein said pitcher is formed of plastics material, said material being thicker in a surrounding wall section of at least said bottom retention section of said connecting slot to provide resistance to a torque force transmitted to said surrounding wall section when a removable closure member of said dispensing fitment is engaged and disengaged.

25. A pitcher as claimed in claim 24 wherein said removable closure is a screw cap.

26. A pitcher as claimed in claim 18 wherein said pitcher has a pouch receiving chamber dimensioned for receiving said pouch with a liquid therein and with said fitment secured in said connecting slot, said liquid extending a predetermined distance spaced below a spout neck of said fitment, and an air space defined above said liquid.

27. A pitcher as claimed in claim 20 wherein said pouch has a top and bottom angulated edge sloping upwardly in the direction of said dispensing fitment, said bottom angulated edge resting on said inclined bottom wall.

28. A liquid dispensing fitment formed of polymeric material for securement to a flexible bag, said fitment having a dispensing spout neck having a dispensing end, a removable closure member is adapted to be secured to an open end of said spout neck, a flange wall formed integral about an attachment end of said spout neck, said spout neck having a base formation shaped for close fit retention in a connecting slot of a dispensing support member.

29. A liquid dispensing fitment as claimed in claim 28 wherein said base formation has at least a section thereof having opposed parallel vertical walls and wherein said connecting slot has a bottom retention section having opposed straight edges spaced-apart to retain said base formation section having said opposed parallel vertical walls.

30. A liquid dispensing fitment as claimed in claim 29 wherein said base formation is retained by friction fit, said base formation having an upper and lower wall extending transversely to said opposed parallel vertical walls and connected thereto through angled corner brace walls to transfer compression forces to said top and bottom walls when said base formation is compressed between said opposed straight edges of said connecting slot.

31. A liquid dispensing fitment as claimed in claim 28 wherein said attachment flange is a flexible attachment flange formed of a polymerized material having a melt index of between 0.2 to 50 MI and a density of 0.912 to 0.960.

32. A liquid dispensing fitment as claimed in claim 31 wherein said flexible attachment flange is formed of polyethylene materials including HDPE, LDPE, LLDPE and copolymers.

33. A liquid dispensing fitment as claimed in claim 28 wherein said removable closure member is a screw cap removably secured to a threaded free-end portion of said spout neck, and a detachable seal member removably retained about said dispensing opening.

34. A liquid dispensing fitment as claimed in claim 31 wherein said removable closure member is a screw cap, said base formation of said spout neck and said screw cap being formed of a mixture of 30% LLDPE having a density of 0.924 and 70% LDPE having a density of 0.921.

35. A liquid dispensing fitment as claimed in claim 28 wherein said dispensing end of said spout neck is provided with an anti-tampering closure seal member.

36. A liquid dispensing filament as claimed in claim 28 wherein said attachment flange is formed of polymeric material such as PE, PP PET, EVA, EMA, PVC, LLDPE and PP and blends and copolymers of these products in the density range of 0.88 to 0.945 with a Melt Index of 0.25 to 5.0 and single layers of polymer film or co-extrusions, such as, PET/PE; BOPP/PE; Nylon/PE; PP/PE; MetPET/PE; and MetBOPP/PE.
